(19) United States
(12) Patent Application Publication
(10) Pub. No.: US 2017/0316108 A1
(43) Pub. Date: Nov. 2, 2017

(54) DATA PROCESSSING SYSTEM, DATA PROCESSING DEVICE, AND PROGRAM FOR EDITING WEBPAGE

(71) Applicant: SYMMETRIC CO., LTD., Tokyo (JP)

(72) Inventors: Kazutoshi SAKATA, Tokyo (JP); Jun NAKANISHI, Tokyo (JP); Shintaro EGASHIRA, Tokyo (JP)

(73) Assignee: SYMMETRIC CO., LTD., Tokyo (JP)

(21) Appl. No.: 15/526,226

(22) PCT Filed: Nov. 11, 2014
(86) PCT No.: PCT/JP2014/079896

§ 371 Date: May 11, 2017

(51) Int. Cl. G06F 17/30; G06F 17/22; G06F 17/24; H04L 29/08

(52) U.S. Cl. CPC G06F 17/30896; G06F 17/24; G06F 17/2247; H04L 67/28

(57) ABSTRACT

In ordinary mode, a virtual proxy server acquires, from a web server, display instruction data that instructs the display of a webpage, in accordance with a request from a web browser, and delivers the display instruction data to web browser. The web browser displays a webpage according to the display instruction data acquired from virtual proxy server, and stores document data of the display instruction data in a storage device. In editing mode, the virtual proxy server acquires, from storage device, components specified by a user from the display instruction data, in accordance with a request from the web browser, acquires other components from the web server, and delivers the components to the web browser. The web browser performs a test display of a webpage that is being modified, according to display instruction data acquired from virtual proxy server.

### TECHNICAL FIELD

The present invention pertains to a technique for editing a webpage in a terminal device.

### BACKGROUND

A technique in which a web browser that is executed in a terminal device acquires, from a web server, HTML data and image data and the like referred to by the HTML data, and displays a webpage specified by the acquired data, is widely used.

Data that instructs a web browser to display a webpage (hereafter referred to as “display instruction data” in the present application) comprises a plurality of types of components, such as document data that indicates the basic configuration of the webpage described in a language such as HTML, XML or XHTML, content data that indicates an image (still image, moving image) embedded in the webpage, a style sheet that instructs the appearance of the webpage described in a language such as CSS, DSSSL or XSL, and a script that instructs each type of operation with respect to the webpage described in a language such as JavaScript (“JAVASCRIPT” is a trademark in Japan), VBScript or DHTML. Since style sheets and scripts are text data, stylesheets and scripts are sometimes distributed from a web server to a web browser as a part of document data.

A technique of re-using components of display instruction data previously acquired by a web browser from a web server is known. For example, patent document 1 discloses a configuration in which, when a webpage is referred to by document data acquired from a web server, acquired scripts are already stored in a local storage unit, and the web browser re-displays the same webpage, the scripts referred to by document data re-acquired from the web server are acquired from a local storage unit and used, in place of re-acquiring the scripts from an external web server. As such, a technique of storing components referred to by document data acquired from a web server in a local storage unit to be re-used has a purpose of increasing the speed of re-displaying a webpage corresponding to the same URI.

It is sometimes necessary to modify the display content of a webpage displayed in a web browser without modifying the display instruction data of a webpage stored in a web server that is in operation. Examples of this are when the content of a webpage needs to be renewed under conditions in which verifications can only be made during operation, or when a webpage for smartphones that is linked with a webpage for PCs needs to be developed while the webpage for PCs is being distributed.

As a method for satisfying the above-stated requirements, a method in which modifications are made to document data whilst the document data is being distributed from a web server to a web browser in accordance with a request from a web browser can be given. In this method, a developer develops modification instruction data that instructs modifications to be made to document data whilst a web server is distributing document data to a web browser. According to this method, a web browser displays a webpage according to modified document data that differs from document data stored in a web server. Therefore, the display content of a webpage displayed in a web browser differs from the corresponding data that is maintained in a web server.

Another method for satisfying the above-stated requirements can be described in which data such as image data, script and style sheet (hereafter collectively referred to as “resource data”) referred to by document data and used to display a webpage is replaced. In this method, a developer develops resource data for replacement (resource data that replaces the original resource data). According to this method, when a web browser acquires resource data from a web server according to document data acquired from the web server, resource data for replacement is acquired. As a result, the display content of a webpage displayed in a web browser differs from the corresponding data that is maintained in a web server.

According to the former method, a developer needs to repeat a verification operation to confirm the display content of a webpage displayed according to document data modified according to modification instruction data during development. According to the latter method, a developer needs to repeat a verification operation to confirm the display content of a webpage displayed using resource data for replacement during development.

Sometimes, document data distributed from a web server dynamically changes. That is, even if the document data is distributed from a web server according to the same URI, the content sometimes differs according to conditions such as the number of times display is performed or a time of day when display is performed, and the content of GET data or POST data at the time of request. As such, if reproducibility of document data distributed from a web server is poor, verification operation of modification instruction data or resource data for replacement during development becomes difficult.

There can be an upper limit to the number of times the same webpage can be distributed. For example, the number of times a purchase completion page or the like of a product order can be distributed from a web server is usually limited to one, and the same webpage cannot be re-displayed. If a number of requests for a webpage exceeds such an upper limit, document data cannot be acquired, and the above-stated verification operation cannot be continued.

Moreover, sometimes a charge is incurred according to the number of times a webpage is distributed. In such a case, a charge is incurred every time a test display of a webpage is performed for the verification operation, resulting in an increase in development costs.

In consideration of the above-stated background, the purpose of the present invention is to provide a means for facilitating the task of a webpage developer of making modifications to the display content of a webpage.

### SUMMARY

To solve the above-stated problem, the present invention provides, as a first mode, a data-processing system comprising a mode indication data acquisition unit for acquiring mode indication data that indicates whether or not a mode is editing mode, a display instruction data acquisition unit for acquiring display instruction data that instructs display of a webpage in accordance with a request from a web browser, and delivering the display instruction data to the web browser, and a storage instruction unit for instructing a predetermined storage device to store display instruction data acquired by the display instruction data acquisition unit, wherein the display instruction data acquisition unit acquires, from the storage device, at least a part of the display instruction data requested from the web browser if mode indication data acquired by the mode indication data acquisition unit indicates editing mode.

As a second mode, a configuration may be adopted in which the data-processing system according to the first mode comprises a modification instruction data acquisition unit for acquiring modification instruction data that instructs modifications to display instruction data, and a modification unit for modifying display instruction data acquired by the display instruction data acquisition unit according to modification instruction data acquired by the modification instruction data acquisition unit, wherein the display instruction data acquisition unit delivers, to the web browser, display instruction data that has been modified by the modification unit in accordance with a request from the web browser.

As a third mode, a configuration may be adopted in which, in the data-processing system according to the first or second mode, the display instruction data acquisition unit acquires, from the web browser, component indication data that indicates components that should be acquired from the storage device from among a plurality of components that constitute the display instruction data, and the display instruction data acquisition unit acquires, from the storage device, components that are indicated by the component indication data from among the display instruction data requested from the web browser.

As a fourth mode, a configuration may be adopted in which, in the data-processing system according to the third mode, the mode indication data acquisition unit acquires, from the web browser, the mode indication data that includes the component indication data.

As a fifth mode, a configuration may be adopted in which, in the data-processing system according to the third mode, the display instruction data acquisition unit acquires the component indication data delivered from the web browser according to document data, which is the first component delivered to the web browser in accordance with a request from the web browser from among a plurality of components that constitute the display instruction data.

As a sixth mode, a configuration may be adopted in which, in the data-processing system according to the third mode, the display instruction data acquisition unit includes the mode indication data acquired from the web browser in document data that is the first component delivered to the web browser in accordance with a request from the web browser from among a plurality of components that constitute the display instruction data, and subsequently delivers, to the web browser, the document data that includes the mode indication data.

As a seventh mode, a configuration may be adopted in which the data-processing system according to any of the first to sixth modes comprises a terminal device having a virtual proxy server that transmits/receives data between the web browser and a web server via a network in place of the web browser, wherein the virtual proxy server has the display instruction data acquisition unit, and the web browser has the storage instruction unit.

As an eighth mode, a configuration may be adopted in which the data-processing system according to any of the first to sixth modes comprises a terminal device having the web browser and the storage instruction unit, and a proxy server that transmits/receives data with a web server via a network in place of the terminal device, wherein the proxy server has the display instruction data acquisition unit.

The present invention provides, as a ninth mode, a proxy server, which is a proxy server that transmits/receives data to and from a web server via a network in place of a web browser, comprising a mode indication data acquisition unit for acquiring mode indication data that instructs whether or not the mode is editing mode, and a display instruction data acquisition unit for acquiring display instruction data that instructs display of a webpage, in accordance with a request from a web browser, and delivering the display instruction data to the web browser, wherein if mode indication data acquired by the mode indication data acquisition unit indicates editing mode, the display instruction data acquisition unit acquires, from a predetermined storage device, at least a part of the display instruction data requested from the web browser.

As a tenth mode, a configuration may be adopted in which the proxy server according to the ninth mode comprises a modification instruction data acquisition unit for acquiring modification instruction data that instructs modification of display instruction data, and a modification unit for modifying display instruction data acquired by the display instruction data acquisition unit by using modification instruction data acquired by the modification instruction data acquisition unit, wherein the display instruction data acquisition unit delivers, to the web browser, display instruction data modified by the modification unit in accordance with a request from the web browser.

As an eleventh mode, a configuration may be adopted in which, in the proxy server according to the ninth or tenth mode, the display instruction data acquisition unit acquires, from the web browser, component indication data that indicates components that should be acquired from the storage device from among a plurality of components that constitute the display instruction data, and the display instruction data acquisition unit acquires, from the storage device, components indicated by the component indication data from among the display instruction data requested from the web browser.

The present invention provides, as a twelfth mode, a terminal device comprising a web browser, wherein the web browser comprises a storage instruction unit for instructing a predetermined storage device to store display instruction data that instructs a display of a webpage acquired via a proxy server, and a mode indication unit for delivering, to the proxy server, mode indication data that indicates whether or not a mode is editing mode.

As a thirteenth mode, a configuration may be adopted in which, in the terminal device according to the twelfth mode, the web browser comprises a component indication unit for delivering, to the proxy server, component indication data that indicates components that should be acquired from the storage device from among a plurality of components that constitute the display instruction data.

The present invention provides, as a fourteenth mode, a program for causing a computer to carry out a process of acquiring mode indication data that indicates whether or not a mode is editing mode, a process of acquiring display instruction data that instructs a display of a webpage in accordance with a request from a web browser, and a process of delivering the display instruction data to the web browser, and for causing the computer to acquire at least a part of display instruction data requested from the web browser from a predetermined storage device, if the mode indication data indicates editing mode, in the process of acquiring display instruction data.

As a fifteenth mode, a configuration may be adopted in which the program according to the fourteenth mode causes the computer to carry out a process of acquiring modification instruction data that instructs modifications to display instruction data, and a process for modifying display instruction data acquired in the process of acquiring display instruction data by using the modification instruction data, and causes the computer to deliver, to the web browser, display instruction data that has been modified in the modification process, in the process of delivering, to the web browser, the display instruction data.

As a sixteenth mode, a configuration may be adopted in which the program according to the fourteenth or fifteenth mode causes a computer to acquire, in the process of acquiring display instruction data, from the web browser, component indication data that indicates components that should be acquired from the storage device from among a plurality of components that constitute the display instruction data, and acquire, in the process of acquiring display instruction data, from the storage device, components indicated by the component indication data from among display instruction data requested from the web browser.

As a seventeenth mode, a configuration may be adopted in which the program according to any of the fourteenth to sixteenth modes causes the computer to function as the web browser, the computer functioning as a virtual proxy server that transmits/receives data to and from a web server via a network in place of the web browser, and the virtual proxy server carrying out a process of acquiring the display instruction data.

The present invention provides, as an eighteenth mode, a program for causing a computer to function as a web browser, and causing the computer that functions as the web browser to carry out a process of instructing a predetermined storage device to store display instruction data that instructs the display of a webpage acquired via a proxy server, and a process of delivering, to the proxy server, mode indication data that indicates whether or not a mode is editing mode.

As a nineteenth mode, a configuration may be adopted in which the program according to the eighteenth mode causes the computer that functions as the web browser to carry out a process of delivering, to the proxy server, component indication data that indicates components that should be acquired from the storage device from among a plurality of components that constitute the display instruction data.

According to the present invention, during the task of a web developer of making modifications to the display content of a webpage, at least a part of the display instruction data of the webpage acquired from a web server is stored in a storage device when not in editing mode and at least a part of the display instruction data stored in the storage device is used to display the webpage when in editing mode. Therefore, reproducibility is ensured when repeating a verification operation of making modifications to a webpage corresponding to the same URI and performing a test display of the modified webpage, facilitating the developing task.

### BRIEF DESCRIPTION OF THE DRAWINGS

FIG. 1 is a drawing illustrating the overall configuration of a data-processing system according to the first embodiment.

FIG. 2 is a drawing illustrating the basic configuration of a computer used in a terminal device according to the first embodiment.

FIG. 3 is a drawing illustrating the functional configuration of a terminal device according to the first embodiment.

FIG. 4 is a drawing exemplifying the data configuration of a document database stored in a storage device according to the first embodiment.

FIG. 5 is a drawing exemplifying the data configuration of the resource database stored in a storage device according to the first embodiment.

FIG. 6 is a drawing exemplifying the data configuration of a modification instruction database stored in a storage device according to the first embodiment.

FIG. 7 is a drawing illustrating the functional configuration of a web browser according to the first embodiment.

FIG. 8 is a drawing illustrating the functional configuration of a virtual proxy server according to the first embodiment.

FIG. 9 is a drawing exemplifying a component specification screen displayed by a web browser according to the first embodiment.

FIG. 10A is a drawing illustrating the operation sequence of a data-processing system (transmission of document request data) according to the first embodiment).

FIG. 10B is a drawing illustrating the operation sequence of a data-processing system (continuation of FIG. 10A) according to the first embodiment.

FIG. 11 is a drawing illustrating the operation sequence of a data-processing system (transmission of resource request data) according to the first embodiment.

FIG. 12 is a drawing illustrating the overall configuration of a data-processing system according to a modified example.

### DETAILED DESCRIPTION

Following is an explanation of a data-processing system 1 according to a first embodiment of the present invention. Data-processing system 1 is a system for supporting the task of a webpage developer (user) of making modifications to the display content of a webpage.

FIG. 1 is a drawing illustrating the overall configuration of data-processing system 1. Data-processing system 1 comprises a terminal device 11 used by a user, and a web server 12 that distributes the display instruction data of a webpage to a terminal device that is the request source. Terminal device 11 and web server 12 mutually perform data communication via a network 9.

In data-processing system 1, a user develops modification instruction data for modifying document data (HTML data or the like) and/or resource data for replacement referred to by the document data, distributed by web server 12. The user repeats a verification operation of performing a test display of a webpage by using modification instruction data and resource data for replacement, which are being developed, and if a defect exists, making amendments to the modification instruction data and resource data for replacement.

The completed modification instruction data is uploaded to a reverse proxy server (omitted in FIG. 1) that distributes document data in place of web server 12, for example. Subsequently, modifications are made according to modification instruction data with respect to the document data in the reverse proxy server whilst document data is distributed from web server 12 to a terminal device that is the request source, in accordance with a document data request from an arbitrary terminal device, and the modified document data is distributed to the terminal device that is the request source. The completed resource data for replacement is uploaded to web server 12, which is, for example, the distribution source of the resource data before replacement, and replaces the resource data before replacement. As a result, the display content of a webpage displayed by a web browser executed in a terminal device becomes the display content after modification intended by the user.

Here, in place of the method for uploading completed modification instruction data to a reverse proxy server, a method for uploading document data that has been modified according to modification instruction data to a web server and replacing the original document data with modified document data may be adopted. Moreover, in place of the above-stated method for replacing original resource data stored in web server 12 with completed resource data for replacement, and rewriting the reference destination of resource data in document data stored in web server 12 with resource data for replacement whilst maintaining the original resource data may be adopted.

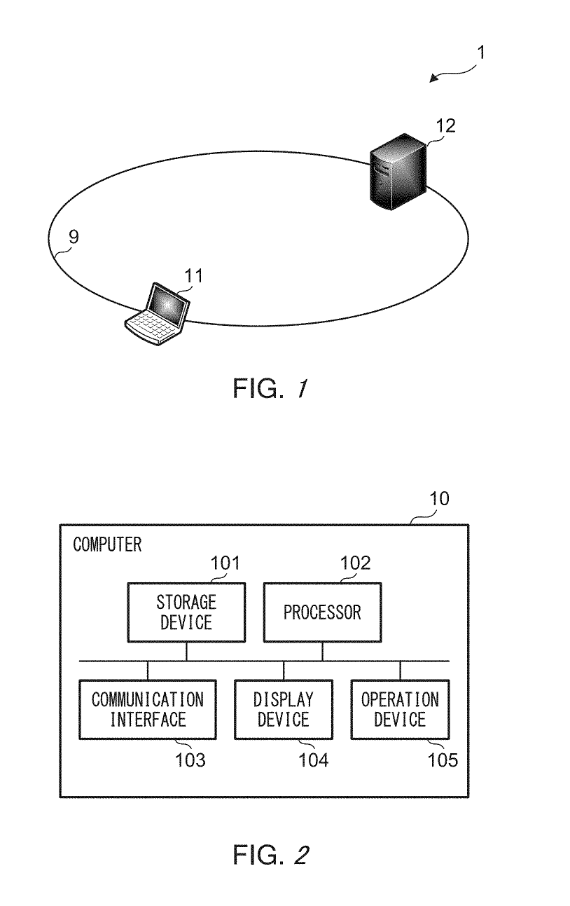

The hardware configuration of terminal device 11 is a general computer for a terminal device, for example. FIG. 2 is a drawing illustrating the basic configuration of a computer 10, which is an example of a hardware device of terminal device 11. Computer 10 comprises a storage device 101 that stores various types of data, a processor 102 that carries out various types of processes according to a program stored in storage device 101, a communication interface 103 that performs data communication with web server 12 via network 9, a display device 104 such as a liquid-crystal display that displays various types of images to a user, and an operation device 105 such as a keyboard that receives an operation of a user.

Here, computer 10 may be connected to an external storage device, display device, operation device and the like via a data input/output interface.

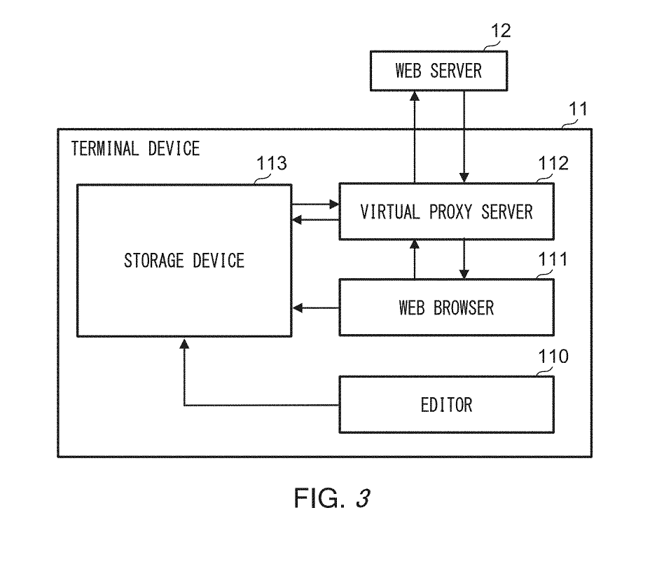

FIG. 3 is a drawing illustrating the functional configuration of terminal device 11. Terminal device 11 functions as a device comprising the configuration illustrated in FIG. 3, by carrying out a process according to a program stored in storage device 101.

Terminal device 11 comprises, as functional components, an editor 110, a web browser 111, a virtual proxy server 112, and a storage device 113.

Editor 110 is a tool for a user to use to describe a source code for modification instruction data or resource data for replacement (text-format resource data and the like for scripts, style sheets, etc.). A source code of modification instruction data generated by editor 110 according to the operation of a user is converted into execution-format modification instruction data (conversion program) by a compiler, delivered to storage device 113, and stored in storage device 113. Further, text-format resource data such as a script or a style sheet generated by editor 110 according to the operation of a user is delivered to storage device 113 from editor 110, and stored in storage device 113.

Web browser 111, in addition to the basic function of the web browser (function of interpreting display instruction data and displaying a webpage), comprises, as extra functions, a function of instructing storage device 113 to store document data used to display a website under predetermined conditions described below, and a function of prompting a user to specify data the user would like to use for a test display of a webpage with respect to each of document data, resource data and modification instruction data, stored in storage device 113. Web browser 111 is realized by incorporation thereinto of an add-in program that adds the extra functions to an ordinary web browser, for example.

Web browser 111 comprises an ordinary mode and an editing mode, and a user can switch between these modes. In data-processing system 1, a user can operate web browser 111 in ordinary mode by not specifying either of the components (document data or resource data) on a component specification screen described below, and operate web browser 111 in editing mode by specifying any of the components.

In ordinary mode, web browser 111 behaves largely similarly to an ordinary web browser. Meanwhile, in editing mode, a URI to which a parameter that specifies a component (document data or resource data) specified by a user on the component specification screen is added is delivered to virtual proxy server 112. As a response to this URI, web browser 111 receives data that is acquired from storage device 113 for components (document data or resource data) specified by a user and acquired from web server 12 for components not specified by the user. As a result, web browser 111 performs a test display of a webpage that is being developed and that uses resource data for replacement.

Virtual proxy server 112 comprises a basic function as a so-called forward proxy server that performs data communication with web server 12 in place of web browser 111. Virtual proxy server 112, in addition to the basic function, comprises, as an extra function, a function of reading, from storage device 113, a component specified by the parameter, and delivering the component to web browser 111, if a parameter that specifies a component (document data or resource data) to a URI that is delivered from web browser 111 is added. Virtual proxy server 112 comprises a function of instructing storage device 113 to store document data acquired from web server 12 in accordance with a request from web browser 111 under predetermined conditions described below.

Storage device 113 stores, in addition to modification instruction data generated by a compiler according to a source code described by editor 110, and resource data (text-format component such as a script or a style sheet) described by editor 110, resource data (image data and the like) acquired from an external device, for example. Further, storage device 113 stores document data acquired by virtual proxy server 112 from web server 12 in accordance with a request from web browser 111.

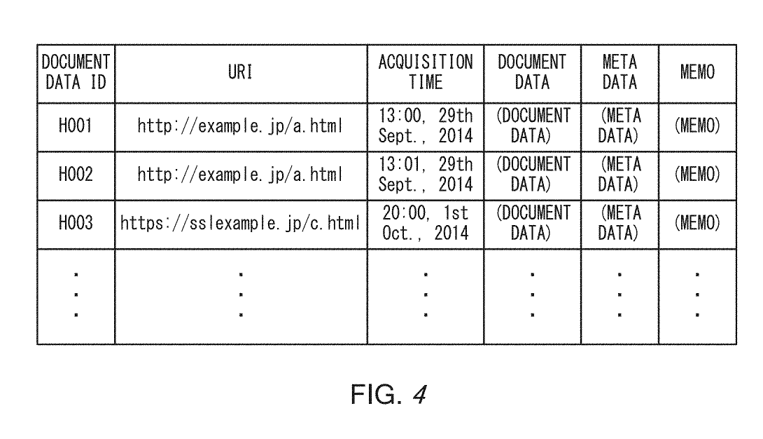

Storage device 113 stores a document database, which is a database for managing document data stored in storage device 113. FIG. 4 is a drawing exemplifying the data configuration of a document database. A document database is a collection of data records corresponding to each of a plurality of items of document data. The data records of a document database include, as fields, “document data ID,” “URI,” “acquisition time,” “document data,” “meta data,” and “memo.”

IDs that identify document data are stored in the “document data ID” field. The URIs of document data are stored in the “URI” field. Data indicating time at which document data is acquired by web browser 111 is stored in the “acquisition time” field. Document data is stored in the “document data” field. Here, identification data such as the file names of document data may be stored in the “document data” field in place of the document data. Various types of meta data such as TTL (time to live), session ID, protocol name, GET data and POST data are stored in the “meta data” field. Data indicating memos input by a user is stored in the “memo” field. Here, a plurality of items of document data corresponding to the same URI may be stored in storage device 113. Accordingly, the same URI is sometimes stored in the “URI” field of different data records of a document database.

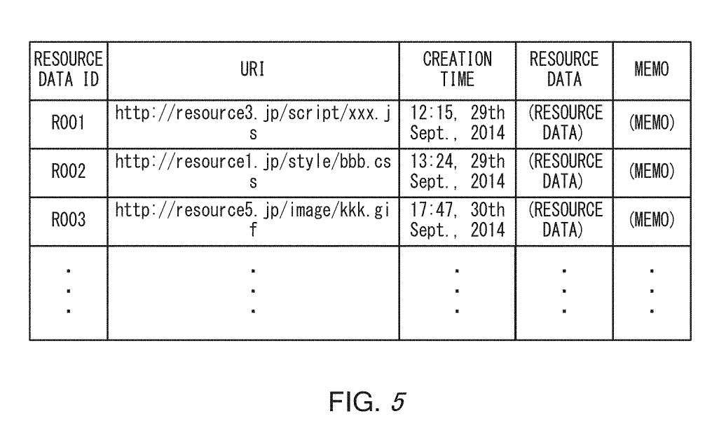

Storage device 113 stores a resource database, which is a database for managing resource data (resource data for replacement) stored in storage device 113. FIG. 5 is a drawing exemplifying the data configuration of a resource database. A resource database is a collection of data records corresponding to each of a plurality of items of resource data for replacement. The data records of a resource database include, as fields, “resource data ID,” “URI,” “creation time,” “resource data,” and “memo.”

IDs that identify resource data for replacement are stored in the “source ID” field. URIs (URIs of reference destinations described in document data) of reference destinations of resource data before replacement corresponding to resource data for replacement are stored in the “URI” field. The creation times of resource data for replacement are stored in the “creation time” field. Resource data for replacement is stored in the “resource data” field. Here, identification data such as file names of resource data for replacement may be stored in place of the resource data for replacement in the “resource data” field. Data indicating memos input by a user is stored in the “memo” field. Here, a plurality of items of resource data for replacement corresponding to the same URI may be stored in storage device 113. Accordingly, the same URI is sometimes stored in the “URI” field of different data records of a resource database.

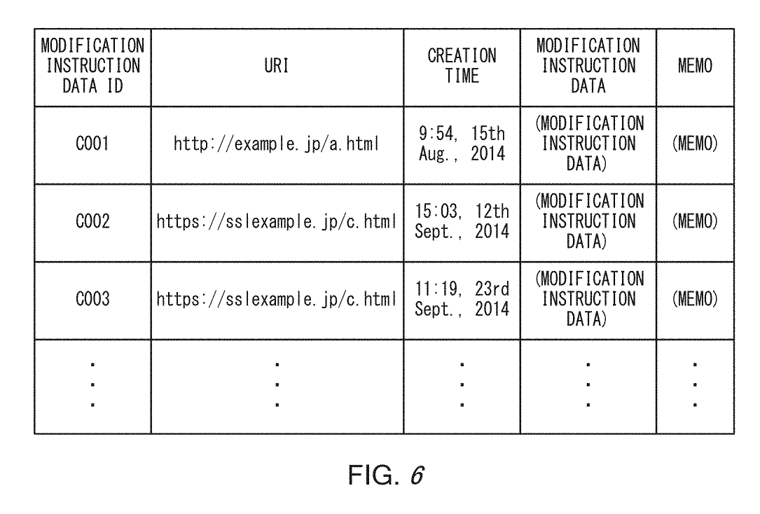

Storage device 113 stores a modification instruction database, which is a database for managing modification instruction data stored in storage device 113. FIG. 6 is a drawing exemplifying the data configuration of a modification instruction database. A modification instruction database is a collection of data records corresponding to each of a plurality of items of modification instruction data. The data records of a modification instruction database include, as fields, “modification instruction data ID,” “URI,” “creation time,” “modification instruction data,” and “memo.”

IDs that identify modification instruction data are stored in the “modification instruction data ID” field. URIs of document data that can be modified are stored in the “URI” field. The creation times of modification instruction data are stored in the “creation time” field. Modification instruction data is stored in the “modification instruction data” field. Here, identification data such as file names of modification instruction data may be stored in place of modification instruction data in the “modification instruction data” field. Data indicating memos input by a user is stored in the “memo” field.

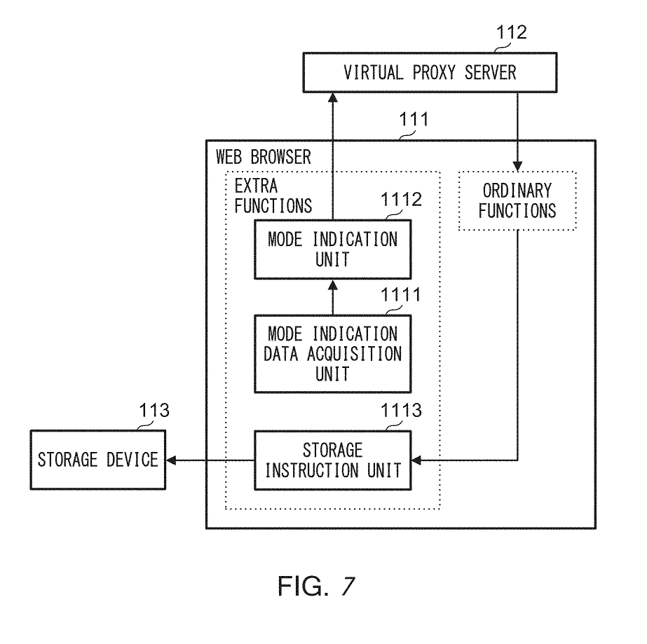

Next, the functional configurations of web browser 111 and virtual proxy server 112 are explained. FIG. 7 is a drawing illustrating the functional configuration provided by web browser 111. Web browser 111, as described above, comprises extra functions in addition to the ordinary functions of a web browser. Following is an explanation of the extra functions provided by web browser 111; explanation of the ordinary functions of a web browser is omitted. Web browser 111 comprises a mode indication data acquisition unit 1111, mode instruction unit 1112, and storage instruction unit 1113.

Mode indication data acquisition unit 1111 acquires mode indication data generated according to a user's operation. In data-processing system 1, mode indication data indicates whether the current mode of web browser 111 is ordinary mode or editing mode, and serves the role of component indication data that indicates the components that virtual proxy server 112 should acquire from storage device 113 in editing mode.

In data-processing system 1, mode indication data is integrated in a URI that is delivered from web browser 111 to virtual proxy server 112. Following are examples of mode indication data acquired by mode indication data acquisition unit 1111.
(1) http://example.jp/a.html
(2) http://example.jp/a/html?DocumentID=H001&ResourceID=R001&ResourceID=R002&ConversionID=C001
(3) httP://example.jp/a.html?ConversionID=C001

The URIs in (1) and (3) above serve as mode indication data that indicates ordinary mode. That is, URIs to which no parameters beginning with “DocumentID=” or “ResourceID=” are added indicate ordinary mode.

Meanwhile, the URI in (2) above serves as mode indication data indicating editing mode. That is, URIs to which a parameter beginning with “DocumentID=” and/or “ResourceID=” is added indicate editing mode.

Mode instruction unit 1112 generates document request data that includes mode indication data (URI) acquired by mode indication data acquisition unit 1111 and requests document data, and delivers the document request data to virtual proxy server 112. Mode indication data included in document request data, as described above, also serves as component indication data that indicates components that virtual proxy server 112 should acquire from storage device 113 in editing mode. Accordingly, mode instruction unit 1112 also serves as a component indication unit that delivers component indication data to virtual proxy server 112.

Storage instruction unit 1113 causes a document database (FIG. 4) to store document data acquired by web browser 111 from web server 12 via virtual proxy server 112. Here, in the present embodiment, storage instruction unit 1113 does not cause a document database to store document data acquired by virtual proxy server 112 from storage device 113 and document data that has been modified in virtual proxy server 112, from among document data acquired by web browser 111 from virtual proxy server 112. However, a configuration may be adopted in which storage instruction unit 1113 causes a document database to store all document data acquired by web browser 111 from virtual proxy server 112 (without questioning whether the data is acquired by virtual proxy server 112 from web server 12 or storage device 113, or whether or not the data has been modified in virtual proxy server 112).

When storing document data in a document database, storage instruction unit 1113 assigns a unique document data ID to document data in a document database, delivers the assigned document data ID to storage device 113 along with the URI of the document data, acquisition time, document data and meta data, and adds these data to the document database as a new data record.

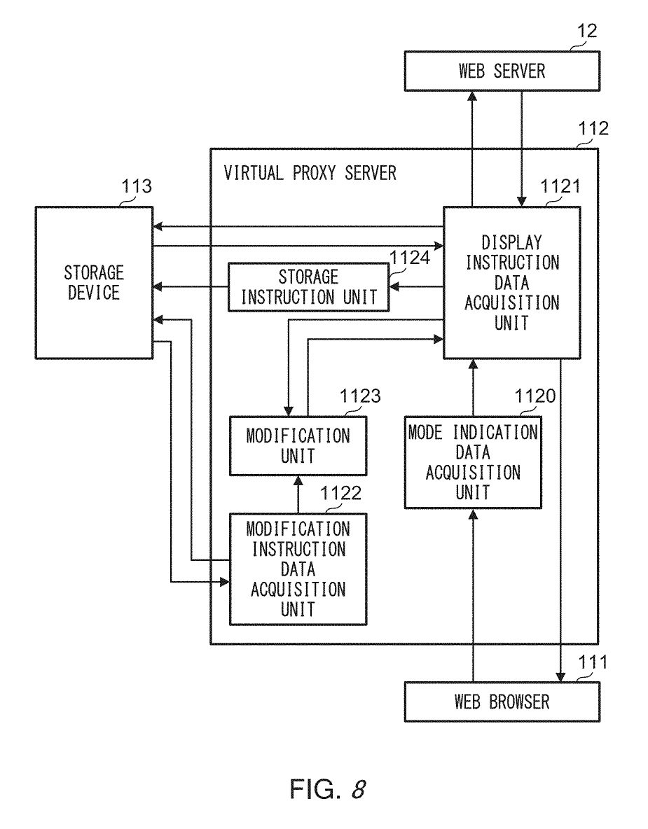

FIG. 8 is a drawing illustrating the functional configuration provided by virtual proxy server 112. Virtual proxy server 112, as described above, comprises extra functions in addition to the ordinary functions of a proxy server (forward proxy server). Following is an explanation of the extra functions provided by virtual proxy server 112; explanation of the ordinary functions of a proxy server is omitted. Virtual proxy server 112 comprises a mode indication data acquisition unit 1120, a display instruction data acquisition unit 1121, a modification instruction data acquisition unit 1122, a modification unit 1123, and a storage instruction unit 1124.

Mode indication data acquisition unit 1120 acquires document request data delivered from web browser 111. URIs included in document request data delivered from web browser 111, as described above, are data (mode indication data) indicating whether the current mode of the web browser 111 is ordinary mode or editing mode, and are also data (component indication data) that instructs components virtual proxy server 112 should acquire from storage device 113 in editing mode. Mode indication data acquisition unit 1120 delivers, to display instruction data acquisition unit 1121, URIs (mode indication data, component indication data) included in document request data acquired from web browser 111.

Display instruction data acquisition unit 1121 acquires document data from storage device 113 (when document data ID is specified) or web server 12 (when document data ID is not specified), according to the presence/absence of specification of document data ID in URIs acquired from web browser 111 via mode indication data acquisition unit 1120.

If a modification instruction data ID is not specified in a URI acquired from web browser 111, display instruction data acquisition unit 1121 delivers acquired document data as it is to web browser 111. Meanwhile, if a modification instruction data ID is specified in a URI acquired from web browser 111, display instruction data acquisition unit 1121 delivers acquired document data to modification unit 1123 (described below), and delivers document data modified by modification unit 1123 to web browser 111. Moreover, if a document data ID is not specified and a modification instruction data ID is specified in a URL acquired from web browser 111, display instruction data acquisition unit 1121 delivers document data acquired from web server 12 to storage instruction unit 1124 (described below).

Modification instruction data acquisition unit 1122 acquires, from storage device 113, modification instruction data identified by a modification instruction data ID specified in a URI acquired from web browser 111 via mode indication data acquisition unit 1120. Modification instruction data acquisition unit 1122 delivers acquired modification instruction data to modification unit 1123.

Modification unit 1123 receives, from display instruction data acquisition unit 1121, document data acquired by display instruction data acquisition unit 1121 from web server 12 or storage device 113, and receives, from modification instruction data acquisition unit 1122, modification instruction data acquired by modification instruction data acquisition unit 1122 from storage device 113. Modification unit 1123 makes modifications to document data delivered from display instruction data acquisition unit 1121, according to modification instruction data delivered from modification instruction data acquisition unit 1122. Modification unit 1123 delivers modified document data to display instruction data acquisition unit 1121.

Storage instruction unit 1124 causes a document database (FIG. 4) to store document data delivered from display instruction data acquisition unit 1121. When causing a document database to store document data similarly to the storage instruction unit 1113 of web browser 111, storage instruction unit 1124 assigns a unique document data ID to document data in the document database, delivers the assigned document data ID to storage device 113 along with the URI of document data, acquisition time, document data, and meta data, and adds these data to the document database as a new data record.

As described above, display instruction data acquisition unit 1121 delivers, to web browser 111, document data corresponding to a URI acquired from web browser 111 via mode indication data acquisition unit 1120. Web browser 111 displays a webpage according to document data delivered from virtual proxy server 112. If reference information for resource data is described in document data acquired by web browser 111 from virtual proxy server 112, web browser 111 generates, as a basic function of the web browser, resource request data including the reference information, that is, the URIs of the resource data, and delivers the data to virtual proxy server 112.

Display instruction data acquisition unit 1121 of virtual proxy server 112 acquires URIs included in resource request data delivered from web browser 111. If one or more specifications of resource data IDs exist in URIs included in document request data acquired from web browser 111 in advance, display instruction data acquisition unit 1121 extracts the data record of these resource data IDs from a resource database (FIG. 5), and determines whether or not any of the URIs of the extracted data record match a URI included in the resource request data. If any of the URIs of the data record extracted from the resource database matches a URI included in the resource request data, display instruction data acquisition unit 1121 acquires, from storage device 113, resource data for replacement corresponding to a data record including the same URI as a URI included in resource request data from among data records extracted from the resource database.

Meanwhile, if none of the URIs included in a data record extracted from a resource database matches a URI included in resource request data as described above, or if a resource data ID is not specified in a URI included in document request data acquired by display instruction data acquisition unit 1121 from web browser 111 in advance, display instruction data acquisition unit 1121 acquires resource data from web server 12 according to a URI included in resource request data.

Display instruction data acquisition unit 1121 delivers, to web browser 111, resource data acquired from storage device 113 or web server 12 according to resource request data from web browser 111.

Next, the task of a user when using data-processing system 1 is explained. A user inputs, to web browser 111, the URI of a webpage to which modifications are to be made. According to the input of this URI, web browser 111 displays an ordinary webpage. The document data of the webpage displayed on web browser 111 is automatically recorded in a document database (FIG. 4).

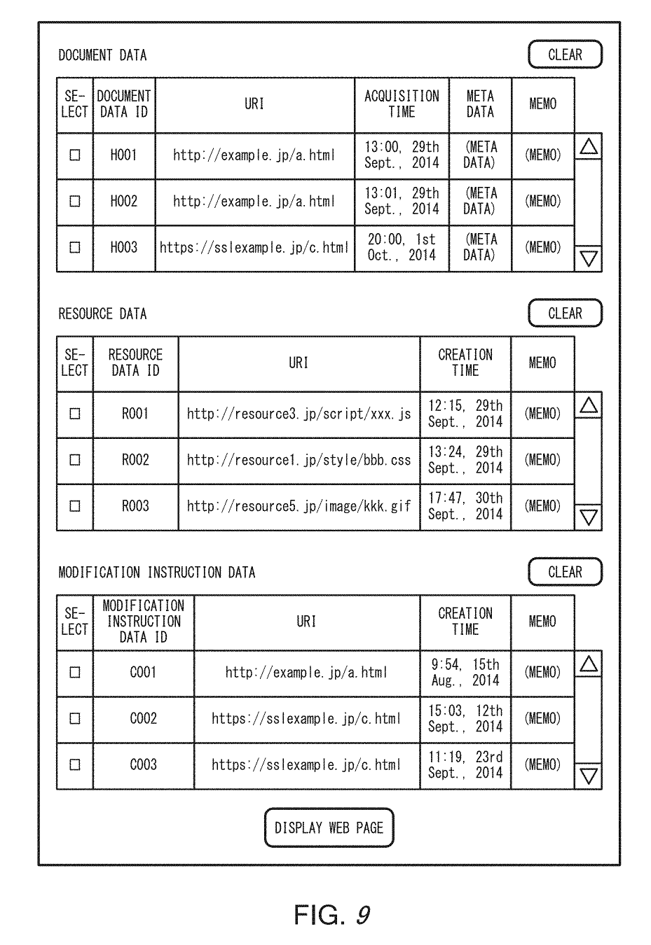

Next, the user performs a predetermined operation with respect to web browser 111, and displays a component specification screen. FIG. 9 is a drawing exemplifying a component specification screen. Document data, resource data and modification instruction data that can be specified are displayed on the component specification screen as a list. Document data, resource data and modification instruction data displayed on the component specification screen are data recorded in each of a document database (FIG. 4), a resource database (FIG. 5) and a modification instruction database (FIG. 6).

The user specifies the document data, resource data, or modification instruction data the user wished to use to test display a webpage, on the component specification screen. The user also can choose not to specify data for each of the document data, resource data and modification instruction data on the component specification screen. Subsequently, if the user selects the “webpage display” button, for example, on the component specification screen, web browser 111 performs a test display of a webpage that has been modified by using a component (document data, resource data for replacement) and/or modification instruction data specified by the user.

The user repeats a task of confirming the display content of a webpage that has been test displayed, and if there is a problem with the resource data for replacement or modification instruction data during development, amending those data, specifying data that has been amended on the component specification screen, and subsequently causing web browser 111 to perform a test display of the modified webpage. As a result, a user is able efficiently to develop resource data for replacement or modification instruction data, for modifying the display content of a webpage.

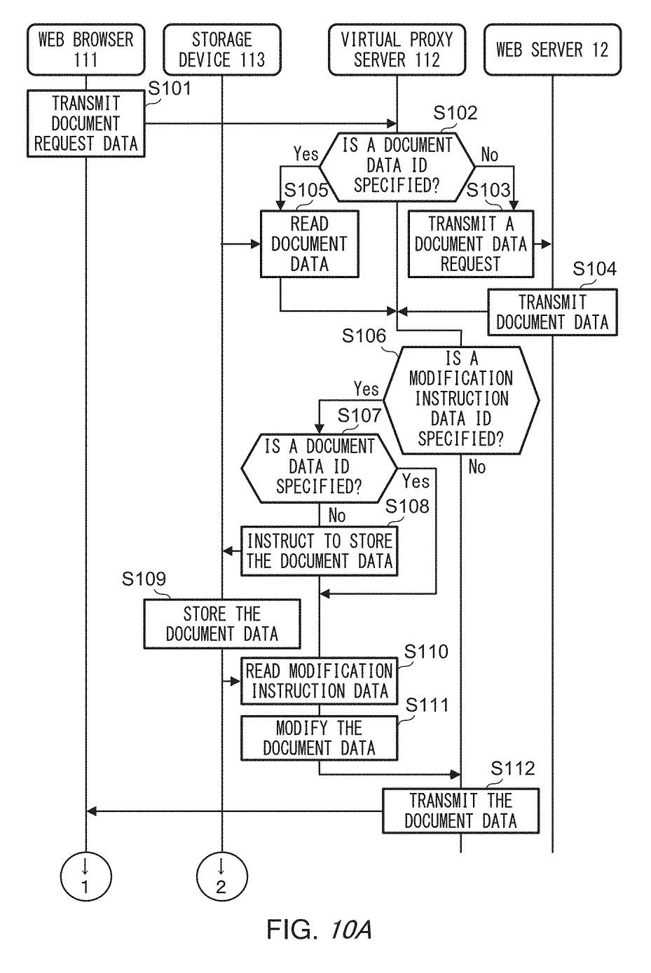

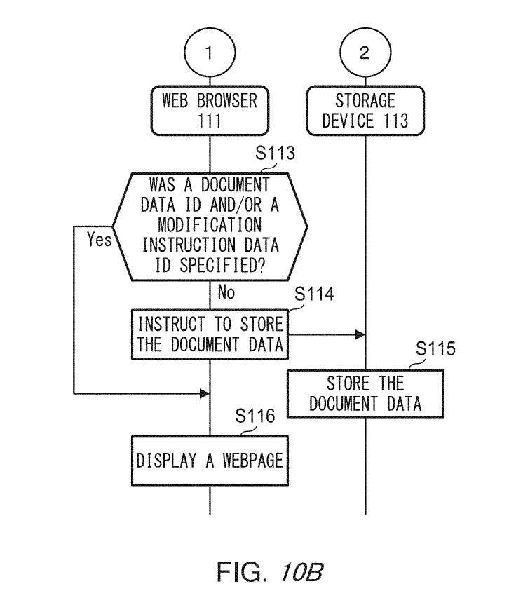

Next, operation of data-processing system 1 is explained. FIG. 10A and FIG. 10B (hereafter collectively referred to as “FIG. 10”) are drawings illustrating the operational sequence of data-processing system 1. If a user inputs an ordinary URI to web browser 111 or specifies document data or the like on the component specification screen (FIG. 9), and subsequently performs a predetermined operation of instructing display of a webpage (selects the “webpage display” button), web browser 111 transmits, to virtual proxy server 112, document request data including a URI corresponding to the user's operation (step S101). Hereafter, if data is delivered among web browser 111, virtual proxy server 112 and storage device 113, this is expressed as “transmission/reception is performed,” for convenience.

In step S101, if a URI generated according to the operation of a user indicates editing mode, web browser 111 does not perform encrypted communication that tunnels virtual proxy server 112. For example, if the URI of document data specified by a user begins with “https:,” web browser 111, in editing mode, modifies this URI to a URI that begins with “http:,” and subsequently performs data communication with virtual proxy server 112 according to a non-encrypted communication protocol. As a result, virtual proxy server 112 is able to perform a process corresponding to document request data or resource request data transmitted from web browser 111.

Virtual proxy server 112 determines whether or not a document data ID is specified in a URI included in document request data transmitted from web browser 111 (step S102). If a document data ID is not specified, (step S102: “No”), virtual proxy server 112 transmits, to web server 12, a document data request according to a URI included in document request data (S103). Web server 12 transmits document data corresponding to the request to virtual proxy server 112 (step S104).

Meanwhile, if a document data ID is specified in a URI included in document request data (step S102: “Yes”), virtual proxy server 112 reads the document data of the specified document data ID from the document database (FIG. 4) (step S105).

Next, virtual proxy server 111 determines whether or not a modification instruction data ID is specified in a URI included in document request data (step S106). If a modification instruction data ID is not specified (step S106: “No”), virtual proxy server 112 skips to step S112 without performing the processes of steps S107, S108, S110 and S111, explained below.

Meanwhile, if a modification instruction data ID is specified in a URI included in document request data (step S106: “Yes”), virtual proxy server 112 determines whether or not a document data ID is specified in a URI included in the document request data (step S107). If a document data ID is specified (step S107: “Yes”), virtual proxy server 112 skips to step S110 without performing the process of step S108 explained below. If a document data ID is not specified (step S107: “No”), virtual proxy server 112 adds a document data ID to document data (document data acquired from web server 12) received in step S104, and subsequently delivers, to storage device 113, document data along with the added document data ID, URI of the document data and the like, and instructs the document database to store these data (step S108). Storage device 113 adds a new data record to the document database according to the instruction of virtual proxy server 112, and stores, in the added data record, data delivered from virtual proxy server 112 (step S109).

Next, virtual proxy server 112 reads, from a modification instruction database (FIG. 6), modification instruction data identified by a modification instruction data ID specified in a URI (step S111). Then, virtual proxy server 112 modifies document data acquired from web server 12 in step S104 or document data read from the document database in step S105, according to modification instruction data read from the modification instruction database in step S110 (step S111).

Next, virtual proxy server 112 transmits, to web browser 111, document data acquired as described above (step S112). When web browser 111 receives document data transmitted from virtual proxy server 112, web browser 111 determines whether or not a document data ID and/or a modification instruction data ID was specified in a URI included in the document request data transmitted from virtual proxy server 112 in step S101 (step S113). If a document data ID and/or a modification instruction data ID was specified in the URI included in the document request data (step S113: “Yes”), web browser 111 skips to step S116 without performing the process of step S114 explained below.

Meanwhile, if neither a document data ID nor a modification instruction data ID was specified in the URI included in the document request data (step S113: “No”), web browser 111 adds a document data ID to document data (document data acquired by virtual proxy server 112 from web server 12) received in step S112, and subsequently delivers, to storage device 113, document data along with the added document data ID, the URI of the document data, and the like, and instructs the document database to store these data (step S114). Storage device 113 adds a new data record to the document database according to the instruction of web browser 111, and stores data delivered from web browser 111 in the added data record (step S115).

Web browser 111 displays a webpage according to document data received from virtual proxy server 112 in step S112 (step S116).

Document data acquired by web browser 111 in step S112 often describes reference information for resource data used to display a webpage. When displaying a webpage in step S116, web browser 111 acquires resource data according to reference information described in document data, and displays the webpage using the acquired resource data.

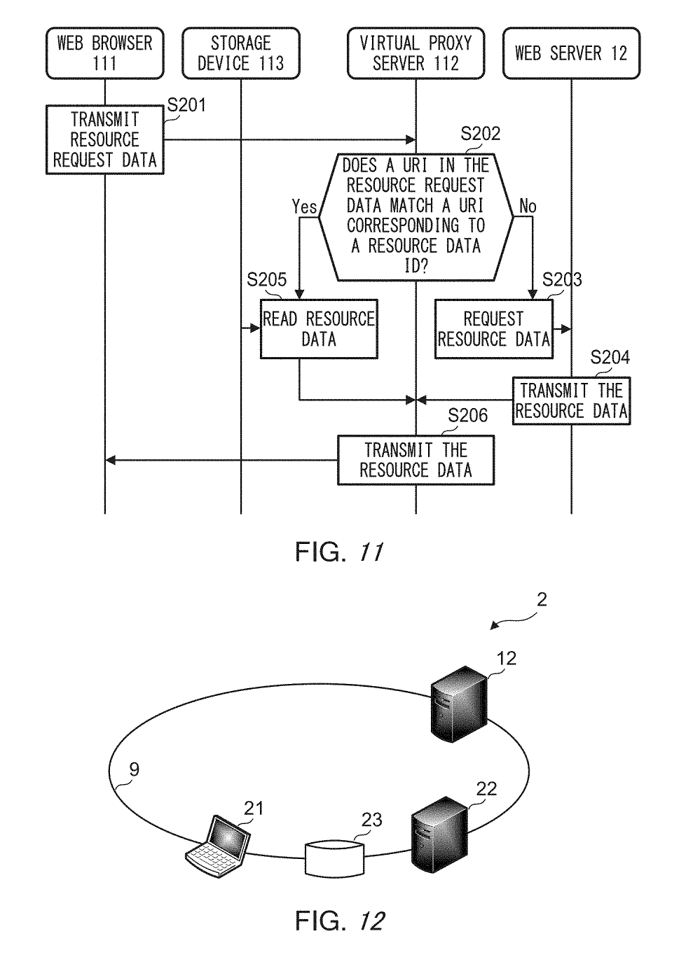

FIG. 11 is a drawing illustrating the sequence of operations performed by data-processing system 1 when web browser 111 acquires resource data according to reference information described in document data. Here, when a plurality of items of reference information are described in document data, the operation illustrated in FIG. 11 is performed for each of the items of reference information.

First, web browser 111 generates resource request data including a URI (URI of resource data) included in reference information, and transmits the data to virtual proxy server 112 (step S201).

Virtual proxy server 112 determines whether or not a URI included in resource request data transmitted from web browser 111 matches a URI corresponding to any of the resource data IDs that were specified in the URI included in document request data received from web browser 111 (step S202). Specifically, first, if a resource data ID was not specified in the URI included in document request data received in step S101, virtual proxy server 112 determines this as “No” in the determination in step S202. If one or more resource data IDs were specified in the URI included in document request data received in step S101, virtual proxy server 112 extracts data records corresponding to those resource data IDs from the resource database (refer to FIG. 5). Then, virtual proxy server 112 retrieves a data record including the URI included in the resource request data from among the extracted data records. If this retrieval fails, virtual proxy server 112 determines this as “No” in the determination of step S202. Meanwhile, if a data record including the URI included in the resource request data is retrieved from among the data records extracted from the resource database, virtual proxy server determines this as “Yes” in the determination of step S202.

If the determination result of step S202 is “No,” virtual proxy server 112 transmits a resource data request to web server 12 according to the URI included in the resource request data (S203). Web server 12 transmits resource data corresponding to the request to virtual proxy server 112 (step S204).

Meanwhile, if the determination result of step S202 is “Yes,” virtual proxy server 112 reads the resource data for replacement from among data records that are extracted from the resource database and that include a URI included in the resource request data (step S205).

Then, virtual proxy server 112 transmits, to web browser 111, resource data received from web server 12 in step S204 or resource data for replacement read from storage device 113 in step S205 (step S206). Web browser 111 displays the webpage in step S116 using the resource data transmitted from virtual proxy server 112 in step S206 or resource data for replacement.

According to the data-processing system 1 described above, document data used by web browser 111 to display a webpage in ordinary mode is stored, and this document data can be reused in editing mode. Accordingly, when a test display of a webpage is repeatedly performed, reproducibility is maintained, while inconveniences such as a limited number of times display can be performed, and charges, are avoided.

### MODIFICATIONS

The embodiment described above is one specific example of the present invention, and can be modified in various ways within the scope of creative ideas of the present invention. Examples of such modifications are indicated below. Here, the embodiment described above and modifications below may be combined, as appropriate.

(1) In the embodiment described above, as indicated in FIG. 3, a configuration in which editor 110, web browser 111, virtual proxy server 112 and storage device 113 are all arranged in one device (terminal device 11) is adopted. These four functions may be distributed among two or more devices.

FIG. 12 is a drawing illustrating the overall configuration of a data-processing system 2. Hereafter, of the components provided by data-processing system 2, the same reference signs as those used in data-processing system 1 are used for the components that are the same as those in data-processing system in the embodiment described above.

Data-processing system 2 comprises, in place of terminal device 11 provided by data-processing system 1, a terminal device 21, a proxy server 22, and a storage device 23. Terminal device 21 comprises the functional configurations of editor 110 and web browser 111 from among the functional configurations provided by terminal device 11 (FIG. 3). Proxy server 22 comprises the functional configuration of virtual proxy server 112 from among the functional configurations provided by terminal device 11. Storage device 23 comprises the functional configuration of storage device 113 from among the functional configurations provided by terminal device 11. Terminal device 12, proxy server 22, and storage device 23 perform data communication with one another via network 9.

The configuration of data-processing system 2 is one example of this modification, and other configurations may be adopted, such as: a configuration in which a terminal device comprising the functions of editor 110, web browser 111 and storage device 113 provided by terminal device, and a proxy server comprising the function of virtual proxy server 112 provided by terminal device 11, are provided; a configuration in which a terminal device comprising the functions of editor 110 and web browser 111 provided by terminal device 11, and a proxy server comprising the functions of virtual proxy server 112 and storage device 113 provided by terminal device 11, are provided; or a configuration in which a terminal device comprising the functions of editor 110, web browser 111 and virtual proxy server 112 provided by terminal device 11, and a storage device independent of the terminal device, comprising the function of storage device 113, are provided.

(2) In the embodiment described above, a configuration is adopted in which virtual proxy server 112 has a modification instruction data acquisition unit 1122 and modification unit 1123, and modifications according to modification instruction data are made to document data. In place thereof, a configuration may be adopted in which web browser 111 has a modification data acquisition unit and a modification unit, and web browser 111 modifies document data acquired from virtual proxy server 112 according to modification instruction data read from storage device.
(3) In the embodiment described above, document data acquired by terminal device 11 from web server 12 is stored in storage device 11 (document database) according to an instruction from virtual proxy server 112, when a user specifies a modification instruction data ID, that is, when document data is modified by virtual proxy server 112, and is stored in storage device 113 (document database) according to an instruction from web browser 111, in all other instances, that is, when document data is not modified by virtual proxy server 112. The feature of whether document data is stored in storage device 113 according to an instruction from web browser 111 or virtual proxy server 112 is not limited to the configuration exemplified in the embodiment. For example, a configuration in which web browser 111 instructs storage device 113 to store all document data, a configuration may be adopted in which virtual proxy server 112 instructs storage device 113 to store all document data, or the like.

However, if encrypted communication that tunnels virtual proxy server 112 is performed between web browser 111 and web server 12, virtual proxy server 112 receives encrypted document data from web server 12. Accordingly, if a configuration in which storage device 113 is made to store all document data acquired by terminal device 11 from web server 12 according to an instruction from virtual proxy server 112 is adopted, a configuration in which virtual proxy server transmits, to web browser 111, encrypted document data received from web server 12, and subsequently receives decrypted document data from web browser 111, or the like, becomes necessary.

Moreover, if modification instruction data ID is specified in a URI included in document request data, document data received by web browser 111 from virtual proxy server 112 as a response to the document request data is document data modified in virtual proxy server 112 after being acquired from web browser 12. Accordingly, if a configuration in which storage device 113 is made to store all document data acquired by terminal device 11 from web server 12 according to an instruction from web browser 111 is adopted, a configuration in which web browser 111 receives document data before modification in addition to document data after modification from virtual proxy server 112, or the like, becomes necessary.

(4) In the embodiment described above, a configuration in which, of the components of display image data acquired by virtual proxy server 112 from web server 12 in accordance with a request from web browser 111, only document data is stored in storage device 113, and resource data referred to by document data is not stored in storage device 113, is adopted. In place thereof, a configuration may be adopted in which all components acquired by virtual proxy server 112 from web server 12 are stored in storage device 113.

According to this modification, a webpage displayed by web browser 111 in ordinary mode can be re-displayed in editing mode without data being acquired by web browser 111 from web server 12. Accordingly, a user is able to develop modification instruction data or resource data for replacement under conditions in which terminal device 11 cannot be connected to network 9.

(5) To facilitate the task of a user of selecting document data, resource data for replacement or modification instruction data on the component specification screen (FIG. 9), a configuration may be adopted in which the combination of data selected once by the user can be stored as a template. According to this modification, when a user wishes to specify resource data or modification instruction data with the same combination in the test display of similar but not identical webpages, the user only needs to specify a template, thus improving task efficiency.
(6) A configuration may be adopted in which web browser 111 does not display data that would be meaningless if selected in the list or displays the data in a different mode (for example, a different color) from data that would be meaningful if selected, on the component specification screen (FIG. 9), to facilitate the task of a user of selecting document data, resource data for replacement, or modification instruction data. Following is an explanation of an example of an operation in which web browser 111 in the present modification modifies the display of the component specification screen according to data specified by a user.

The maximum number of items of document data that can be specified at any one time by a user is one. Accordingly, if a user specifies any item of document data, web browser 111 grays out the display of other items of document data in the list of items of document data so that the user is not able to specify those items of document data, for example. Moreover, the maximum number of items of modification instruction data that can be specified by a user at any one time is one. Accordingly, if a user specifies any item of modification instruction data, web browser 111 grays out the display of other items of modification instruction data in the list of items of modification instruction data so that the user is not able to specify those items of modification instruction data, for example.

Resource data for replacement is developed to replace resource data referred to in any item of document data. Accordingly, a URI referred to in the document data used for the test display of a webpage must match the URI of the resource data for replacement. Accordingly, if any item of document data is specified by a user, web browser 111 grays out the display of items of resource data that do not correspond to the URI referred to by the item of document data specified by the user in the list of items of resource data so that those items of resource data cannot be specified.

Items of resource data referred to by the same URI in one item of document data are the same item of resource data. Accordingly, it would be inconvenient if two or more different items of resource data for replacement corresponding to the same URI were specified in the test display of a webpage. Accordingly, if any item of resource data for replacement is specified by a user, web browser 111 grays out the display of items of resource data corresponding to the same URI within the list of items of resource data so that those items of resource data cannot be specified.

Modification instruction data is developed to modify any item of document data. Accordingly, the URI of document data used for the test display of a webpage must match a URI corresponding to modification instruction data. Accordingly, if any item of document data is specified by a user, web browser 111 grays out the display of items of modification instruction data that do not correspond to the URI of document data specified by the user so that those items of modification instruction data cannot be specified.

If modification instruction data is specified by a user, and the URI corresponding to the modification instruction data specified by the user (URI of document data to be modified according to modification instruction data) is the URI of document data acquired by web server 12 via encrypted communication that tunnels virtual proxy server 112, such as when the URI begins with “https:,” the user must specify a document data ID corresponding to the URI. This is because, if, for instance, a document data ID is not specified but a modification instruction data ID is specified, virtual proxy server 112 acquires encrypted document data from web server 12, and thus virtual proxy server 112 cannot modify the document data according to the modification instruction data specified by the user. Accordingly, if, for example, any item of modification instruction data is specified by a user, web browser 111 grays out the display of items of document data that do not correspond to the URI of the modification instruction data specified by the user in the list of items of document data so that those items of document data cannot be specified, and prompts specification of any of the items of document data that are not greyed out.

(7) A configuration may be adopted in which, to facilitate the task of a user of selecting document data, resource data for replacement, or modification instruction data on the component specification screen (FIG. 9), web browser 111 performs a display by sorting or filtering according to conditions specified by the user based on URI, content such as acquisition time, creation time and memo, or type of data, and the like, for example, in a list of these items of data.
(8) In the embodiment described above, an execution format conversion program is used as modification instruction data. The format of modification instruction data is not limited to an execution format. For example, modification instruction data may be data that indicates the modification rules of document data. In such a case, virtual proxy server uses, as parameters, conversion rules indicated by modification instruction data identified by modification instruction data ID, and modifies document data using conversion tools provided as extra functions in advance.
(9) In the embodiment described above, when virtual proxy server 112 acquires resource data for replacement according to a URI included in resource request data received from web browser 111 (FIG. 11, step S205), a resource data ID that was included in the URI included in the document request data acquired from web browser 111 in advance (FIG. 11, step S101) is used. In place thereof, a configuration may be adopted in which web browser 111 includes a resource data ID in resource request data.

For example, when resource request data is being transmitted, web browser 111 also includes a URI, which was transmitted to virtual proxy server 112 by being included in document request data, in the resource request data as referrer information. Virtual proxy server 112 reads resource data for replacement from storage device 113 by using a resource data ID included in a URI included in the resource request data as referrer information.

Web browser 111 may include a resource data ID in resource request data in place of the URI of resource data included in resource request data. In such a case, if the URI of resource data for replacement specified by a user on the component specification screen matches the URI of resource data referred to by document data, web browser 111 generates resource request data including the resource data ID of resource data for replacement in place of the URI of the resource data referred to by the document data, and transmits the resource request data to virtual proxy server 112.

Moreover, a configuration may be adopted in which, when virtual proxy server 112 transmits document data to web browser 111 according to document request data, virtual proxy server 112 rewrites reference information included in document data to information that refers to the resource data ID of resource data for replacement, and not to the URI of the resource data. In such a case, web browser 111 also generates resource request data including a resource data ID according to reference information, and transmits the resource request data to virtual proxy server 112.

(10) In the embodiment described above, a user specifies components that should be acquired from storage device 113 in editing mode. In place thereof, a configuration may be adopted in which a user specifies switching between ordinary mode and editing mode, but does not specify components. In such a case, virtual proxy server 112 acquires all components of display instruction data from web server 12 in ordinary mode, and reads, from storage device 113, document data or resource data (resource data for replacement) that satisfies predetermined conditions in editing mode, and acquires other document data or resource data from web server 12.

For example, if virtual proxy server 112 acquires, from web browser 111, mode indication data indicating that the mode is editing mode, and subsequently acquires document request data, virtual proxy server 112 extracts a data record corresponding to the URI included in the document request data from the document database (FIG. 4). If no data record was extracted from the document database, virtual proxy server 112 acquires document data from web server 12. Meanwhile, if one or more data records were extracted from the document database, a data record for which the acquisition time is most recent is selected, for example, and document data corresponding to the selected data record is read from storage device 113.

If virtual proxy server 112 acquires resource request data in editing mode, virtual proxy server 112 extracts a data record corresponding to the URI included in the resource request data from the resource database (FIG. 5). If no data record was selected from the resource database, virtual proxy server 112 acquires resource data from web server 12. Meanwhile, if one or more data records were extracted from the resource database, virtual proxy server 112 selects the data record for which the acquisition time is most recent, for example, and reads the resource data corresponding to the selected data record from storage device 113.

According to this modification, the task of a user of specifying components used for a test display is reduced.

(11) In the embodiment described above, terminal device 11 is achieved by computer 10 carrying out processes according to a program. In place thereof, terminal device 11 may be configured as a dedicated device for achieving the functions illustrated in FIG. 3 by use of an integrated circuit or the like.
(12) In the embodiment or modifications described above, the program carried out by computer 10 to achieve terminal device 11 may be provided in the form of a download onto computer 10 via a network, or may be provided in a form of being continuously recorded on a computer-readable recording medium such as a flash memory, and read by computer 10 from the recording medium.

### EXPLANATION OF THE REFERENCE NUMERALS

1 . . . data-processing system
9 . . . network
10 . . . computer
11 . . . terminal device
12 . . . web server
101 . . . storage device
102 . . . processor
103 . . . communication interface
104 . . . display device
105 . . . operation device
110 . . . editor
111 . . .web browser
112 . . . virtual proxy server
113 . . . storage device
1111 . . . mode indication data acquisition unit
1112 . . . mode indication unit
1113 . . . storage instruction unit
1120 . . . mode indication data acquisition unit
1121 . . . display instruction data acquisition unit
1122 . . . modification instruction data acquisition unit
1123 . . . modification unit
1124 . . . storage instruction unit

1-19. (canceled)

20. A data-processing system comprising:
a mode indication data acquisition unit for acquiring mode indication data that instructs whether or not a mode is editing mode;
a display instruction data acquisition unit for acquiring display instruction data that instructs display of a webpage in accordance with a request from a web browser, and delivering the display instruction data to the web browser; and
a storage instruction unit for instructing a predetermined storage device to store display instruction data acquired by the display instruction data acquisition unit; wherein
the display instruction data acquisition unit acquires, from the storage device, at least a part of the display instruction data requested from the web browser if mode indication data acquired by the mode indication data acquisition unit indicates editing mode.

21. A data-processing system set forth in claim 20, comprising:
a modification instruction data acquisition unit for acquiring modification instruction data that instructs modifications to display instruction data; and
a modification unit for modifying display instruction data acquired by the display instruction data acquisition unit according to modification instruction data acquired by the modification instruction data acquisition unit; wherein
the display instruction data acquisition unit delivers, to the web browser, display instruction data that has been modified by the modification unit in accordance with a request from the web browser.

22. A data-processing system set forth in claim 20, wherein:
the display instruction data acquisition unit acquires, from the web browser, component indication data that indicates components that should be acquired from the storage device from among a plurality of components that constitute the display instruction data; and
the display instruction data acquisition unit acquires, from the storage device, components that are indicated by the component indication data from among the display instruction data requested from the web browser.

23. A data-processing system set forth in claim 22, wherein:
the mode indication data acquisition unit acquires, from the web browser, the mode indication data that includes the component indication data.

24. A data-processing system set forth in claim 22, wherein:
the display instruction data acquisition unit acquires the component indication data delivered from the web browser according to document data, which is the first component delivered to the web browser in accordance with a request from the web browser from among a plurality of components that constitute the display instruction data.

25. A data-processing system set forth in claim 22, wherein:
the display instruction data acquisition unit includes the mode indication data acquired from the web browser in document data that is the first component delivered to the web browser in accordance with a request from the web browser from among a plurality of components that constitute the display instruction data, and subsequently delivers, to the web browser, the document data that includes the mode indication data.

26. A data-processing system set forth in claim 20, further comprising:
a terminal device having a virtual proxy server that transmits/receives data between the web browser and a web server via a network in place of the web browser; wherein
the virtual proxy server has the display instruction data acquisition unit, and
the web browser has the storage instruction unit.

27. A data-processing system set forth in claim 20, further comprising:
a terminal device having the web browser and the storage instruction unit; and
a proxy server that transmits/receives data to and from a web server via a network in place of the terminal device; wherein
the proxy server has the display instruction data acquisition unit.

28. A proxy server, which is a proxy server that transmits/receives data to and from a web server via a network in place of a web browser, comprising:
a mode indication data acquisition unit for acquiring mode indication data that instructs whether or not the mode is editing mode; and
a display instruction data acquisition unit for acquiring display instruction data that instructs display of a webpage, in accordance with a request from a web browser, and delivering the display instruction data to the web browser; wherein
if mode indication data acquired by the mode indication data acquisition unit indicates editing mode, the display instruction data acquisition unit acquires, from a predetermined storage device, at least a part of the display instruction data requested from the web browser.

29. A proxy server set forth in claim 28, comprising:
a modification instruction data acquisition unit for acquiring modification instruction data that instructs modification of display instruction data; and
a modification unit for modifying display instruction data acquired by the display instruction data acquisition unit by using modification instruction data acquired by the modification instruction data acquisition unit; wherein
the display instruction data acquisition unit delivers, to the web browser, display instruction data modified by the modification unit in accordance with a request from the web browser.

30. A proxy server set forth in claim 28, wherein:
the display instruction data acquisition unit acquires, from the web browser, component indication data that indicates components that should be acquired from the storage device from among a plurality of components that constitute the display instruction data; and
the display instruction data acquisition unit acquires, from the storage device, components indicated by the components indication data from among the display instruction data requested from the web browser.

31. A terminal device comprising:
a web browser; wherein:
the web browser comprises,
a storage instruction unit for instructing a predetermined storage device to store display instruction data that instructs a display of a webpage acquired via a proxy server, and
a mode indication unit for delivering, to the proxy server, mode indication data that indicates whether or not a mode is editing mode.

32. A terminal device set forth in claim 31, wherein:
the web browser comprises a component indication unit for delivering, to the proxy server, component indication data that indicates components that should be acquired from the storage device from among a plurality of components that constitute the display instruction data.

33. A program for causing a computer to carry out:
a process of acquiring mode indication data that indicates whether or not a mode is editing mode;
a process of acquiring display instruction data that instructs a display of a webpage in accordance with a request from a web browser; and
a process of delivering the display instruction data to the web browser; and
for causing the computer to acquire at least a part of display instruction data requested from the web browser acquired from a predetermined storage device, if the mode indication data indicates editing mode, in the process of acquiring display instruction data.

34. A program set forth in claim 33, for causing the computer to carry out:
a process of acquiring modification instruction data that instructs modifications to display instruction data;
a process for modifying display instruction data acquired in the process of acquiring display instruction data by using the modification instruction data; and
for causing the computer to deliver, to the web browser, display instruction data that has been modified in the modification process, in the process of delivering, to the web browser, the display instruction data.

35. A program set forth in claim 33, for causing a computer to:
acquire, in the process of acquiring display instruction data, from the web browser, component indication data that indicates components that should be acquired from the storage device from among a plurality of components that constitute the display instruction data; and
acquire, in the process of acquiring display instruction data, from the storage device, components indicated by the component indication data from among display instruction data requested from the web browser.

36. A program set forth in any one of claims 33, for:
causing the computer to function as the web browser;
causing the computer to function as a virtual proxy server that transmits/receives data with a web server via a network in place of the web browser; and
causing the virtual proxy server to carry out a process of acquiring the display instruction data.

37. A program for:
causing a computer to function as a web browser; and
causing the computer that functions as the web browser to carry out,
a process of instructing a predetermined storage device to store display instruction data that instructs the display of a webpage acquired via a proxy server, and
a process of delivering, to the proxy server, mode indication data that indicates whether or not a mode is editing mode.

38. A program set forth in claim 37, for:
causing the computer that functions as the web browser to carry out,
a process of delivering, to the proxy server, component indication data that indicates components that should be acquired from the storage device from among a plurality of components that constitute the display instruction data.
